(19) United States
(12) Patent Application Publication
(10) Pub. No.: US 2008/0222289 A1
(43) Pub. Date: Sep. 11, 2008

(54) Resource Allocation

(75) Inventors: Anthony S Conway, Suffolk (GB); Raphael JH Dorne, Suffolk (GB)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS PUBLIC LIMITED COMPANY, Greater London (GB)

(21) Appl. No.: 11/666,293

(22) PCT Filed: Sep. 9, 2005
(86) PCT No.: PCT/GB05/03498

§ 371 Date: Apr. 26, 2007

(30) Foreign Application Priority Data
Oct. 28, 2004 (GB) 0424032.1

(51) Int. Cl. G06F 15/173

(52) U.S. Cl. 709/225

(57) ABSTRACT

In order to satisfy requests for a connection path having a specified capacity between two specified terminations (21, 29) of a telecommunications network, a plurality of distinct subsidiary networks are defined (30, 31, 32, 33, 34, 35), each comprising a subset of the nodes making up the complete network (20), and the connections between the subset of nodes. A connection path is determined by identifying connection path elements between interface nodes (312, 324; 334, 345), etc in each subsidiary network (31, 33 etc), identifying connections (302-312, 324-334, 345-355), between the subsidiary networks, and selecting a complete connection path (21, 302, 312, 324, 334, 345, 355, 29) by combining the connection path elements so identified. By partitioning the problem to be solved in this way, the processing time is reduced and any changes to part of the system only require adjustment of that part.

This invention relates to the allocation of resources to meet requests for provision of those resources. It is particularly, but not exclusively, suited for the allocation of telecommunications resources to meet requests for data transmission. Many telecommunications operators possess very large network infrastructures, often comprised of many interconnected networks, together forming a single very large logical network providing global reach. Across this logical network is a requirement to route point-to-point traffic in order to best utilise the available capacity of the network. Modern telecommunications systems are configured to provide variable capacity (bandwidth) according to the different requirements of the individual users. It is necessary to service many such requests simultaneously. Each request for service will have individual requirements in terms of routing, capacity and quality to be met by the performance of the path. In particular, rather than specifying the required capacity per se, the user may require that a specific quality of service (QoS) measure is achieved. Such performance attributes might include a predetermined minimum error rate, end-to-end delay limitations and constraints on the level of jitter (variations in delay). The network attempts to allocate whatever bandwidth resources are necessary to achieve this. Such resources are generally allocated on demand, although the invention may also be used in systems in which capacity is reserved in advance of it being required.

The optimal routing of many service requests over large networks presents a number of significant problems especially in terms of memory management and algorithm performance, and these become increasingly difficult as the network's size and complexity, and the amount of traffic it carries, increases. For example, determining a simple shortest path in very large networks takes considerable time.

It is known to provide hierarchical routing systems in which the network is broken down into a set of sub-networks, each with its own router which determines the sub-network to which the data should next be forwarded, and the route through that sub-network to achieve that. However, the individual routers do not have visibility of the network as a whole, so the resulting complete end-to-end route may not be optimal.

Although this specification is particularly concerned with allocation of resources in a telecommunications network, similar problems occur in other scheduling situations such as transport and logistics (movement of goods or personnel in a commercial or military situation). Accordingly, the present invention provides in its most general aspect, a method of operating a management system for a set of linked resources in order to satisfy a set of requests for concurrent services, each requiring specified performance attributes, to be reserved in the resources, the method comprising defining a plurality of distinct subsidiary resource sets, each comprising a subset of the resources making up the complete set and the interrelationships between the resources, and further defining an overlay set comprising interrelationships between resources in different subsets, in which a solution to a resource request is determined by identifying elements of the solution in each subsidiary network, and in the overlay set; and selecting a complete solution by combining the solution elements so identified.

Where the linked resources are the elements of a telecommunications network, it should be noted that capacity constraints occur not only at the switching centres (the nodes of the network) but more particularly on the links between them (radio, cable etc). The connections may be considered to be resources, linked together by the switches.

The invention may be used to provide a method of operating a management system for a network in order to satisfy requests for a set of concurrent complete connection paths to be reserved in the network, each path requiring specified performance attributes, the network comprising a plurality of connections between network nodes, each connection having a predetermined capacity, the method comprising defining a plurality of subsidiary networks, each comprising a subset of the nodes making up the complete network and the connections between the subset of nodes, and in which a connection path is identified by identifying connection path elements between interface nodes in each subsidiary network, and connections between the subsidiary networks, and identifying a complete connection path by combining the connection path elements so identified.

The invention also provides a management system for allocating resources selected from a set of linked resources in order to satisfy requests for a set of concurrent services, each requiring specified performance attributes, to be reserved in the resources, the system comprising means for defining a plurality of distinct subsidiary resource sets, each comprising a subset of the resources making up the complete set and the interrelationships between the resources, and for further defining an overlay set comprising interrelationships between resources in different subsets, and means for allocating resources to meet a resource request by identifying elements of the solution in each subsidiary network, and in the overlay set; and means for generating a complete solution by combining the solution elements so identified.

In a further aspect, the invention provides a network management system for allocating a set of concurrent complete connection paths between terminations of a network, the network comprising a plurality of connections between network nodes, each connection having predetermined performance attributes, the system comprising: input means for accepting a request for a connection path, means for defining a plurality of distinct subsidiary networks and storing the details thereof, each subsidiary network comprising a subset of the nodes making up the complete network and the connections between the subset of nodes, means for storing the details of connections between the subsidiary networks, means associated with each subsidiary network for identifying connection paths between its interface nodes, means for identifying connection paths between the subsidiary networks, and means for selecting a complete connection path by combining the connection path elements so identified.

The resource allocation process therefore operates by processing the routing availability for each of a plurality of smaller interconnected parts of the entire network, and for a higher level network in which the individual network parts are each represented as a single-entity node. Routes can then be determined by a combination of routing globally across the high level representation of the network together with local routing within each partitioned network part. The approach taken here is to break down the larger network into a set of smaller interconnected networks, and determine the optimum route through each. This is combined with a global routing function, which determines which request is routed through which networks. By partitioning in this way the problem becomes scaleable. Some theoretical routes may be lost, particularly those which pass through the same subsidiary network more than once, but such routes are likely to be sub-optimal and therefore the processing time gained by failure to consider them outweighs the remote chance that the route might have been selected if considered.

In a preferred arrangement a connection between two subsidiary networks is defined by a pair of port nodes, one in each of the subsidiary networks. At the higher level, connections across and between subsidiary networks are defined by routes between the port nodes.

In a preferred embodiment, the subsidiary networks are defined such that the number of connections between them are minimised, as this maximises the efficiency of the routing process and minimises the possibility that the theoretical optimum route passes through two parts of the same subsidiary. Advantageously, routes within a subsidiary network are identified between each pair of port nodes in the subsidiary network, routes between the subsidiary networks are defined according to the pairs of port nodes connecting them.

It is envisaged that the process would be run on, and the network management system embodied as, one or more suitably-programmed general-purpose computers. As will be understood by those skilled in the art, any or all of the software used to implement the invention can be contained on various transmission and/or storage mediums readable by a suitable computer input device, such as CD-ROM, optically readable marks, magnetic media, punched card or tape, or on an electromagnetic or optical signal, so that the program can be loaded onto one or more general purpose computers or could be downloaded over a computer network using a suitable transmission medium.

The decomposition of very large networks into smaller parts each with responsibility for its own internal routing lends itself to a distributed architecture. Indeed with a distributed approach the size of the network that can be controlled in this way is only limited by the capabilities of the distributed platform itself. In this way the optimisation of networks can be carried out in parallel, further reducing processing time.

For very large networks this approach may be extended to three or more layers, by subdividing one or more of the subsidiary networks into still smaller networks.

An embodiment of the invention will now be described, by way of example, with reference to the Figures, in which

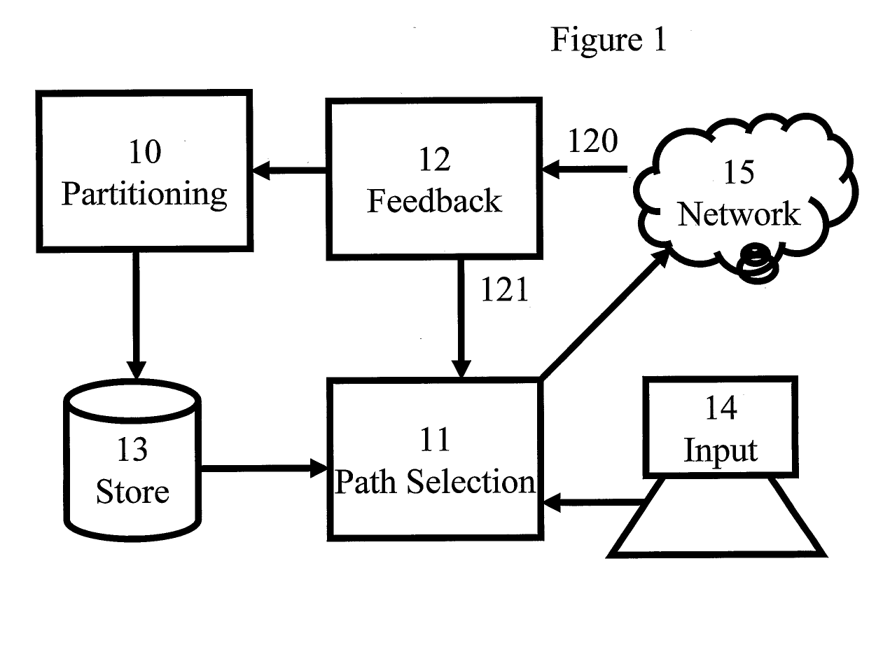

FIG. 1 is a schematic diagram illustrating the process.

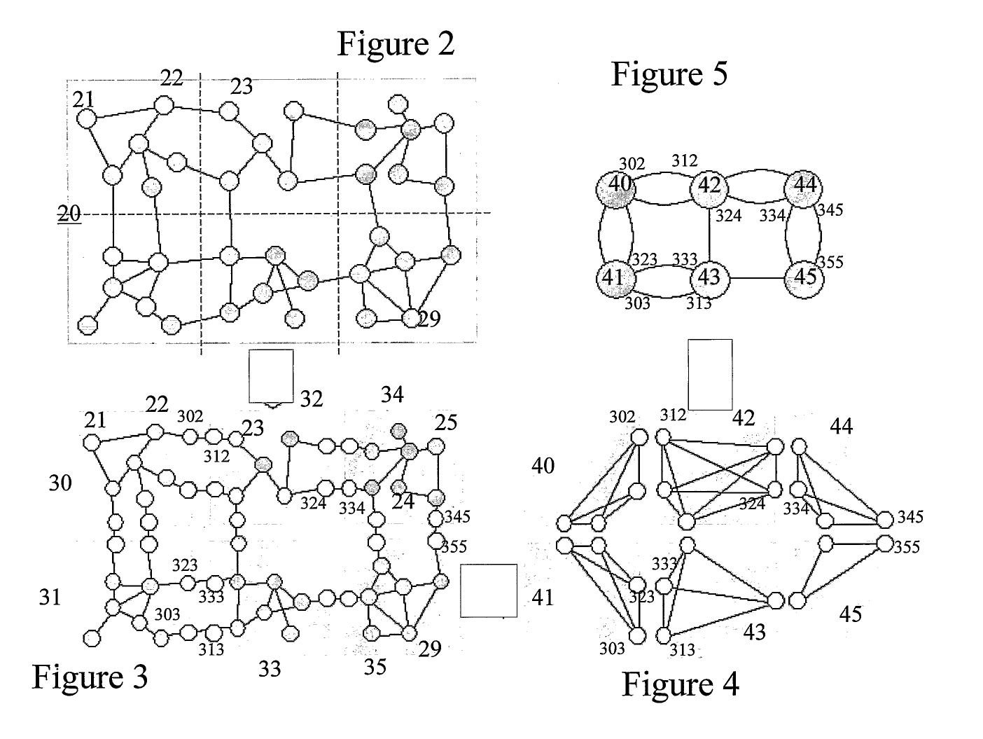

FIGS. 2 to 5 represent a simplified illustrative network and how it may be partitioned

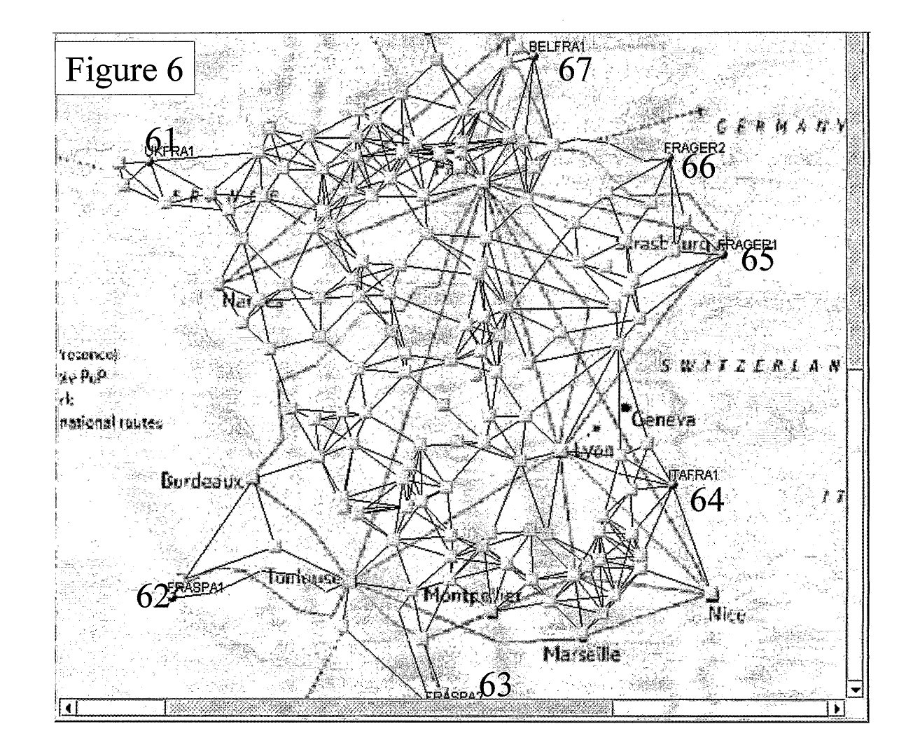

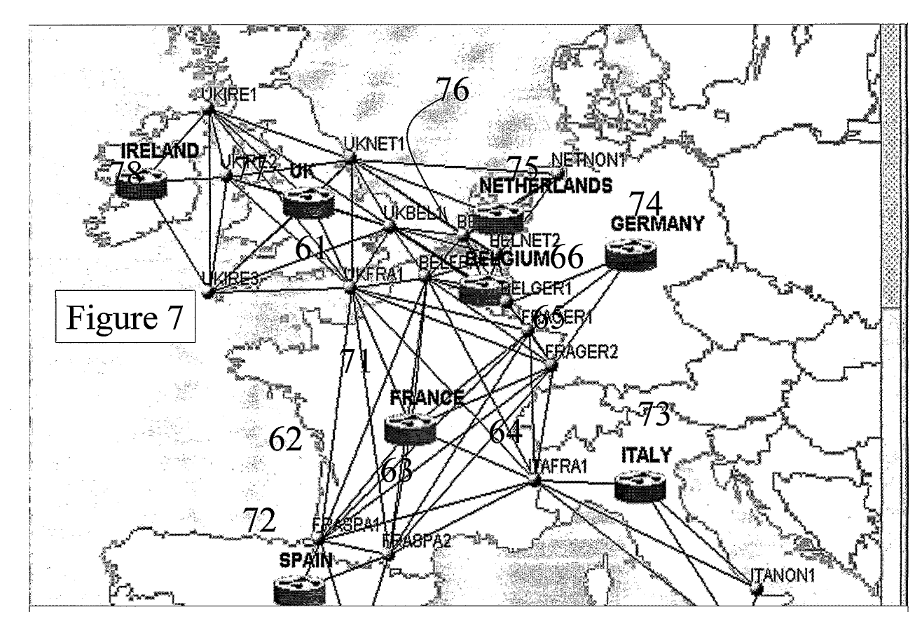

FIGS. 6 and 7 illustrate two levels of a more complex network

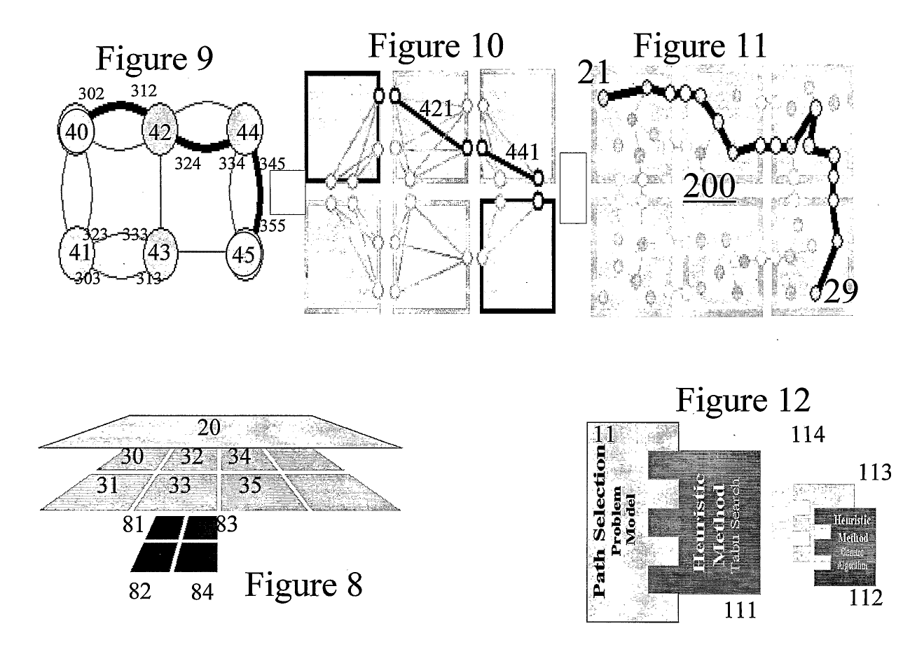

FIG. 8 illustrates a multiple layer variation of FIG. 4

FIGS. 9 to 11 illustrate the generation of a path across the network

FIG. 12 illustrates the use of different path search techniques in the invention

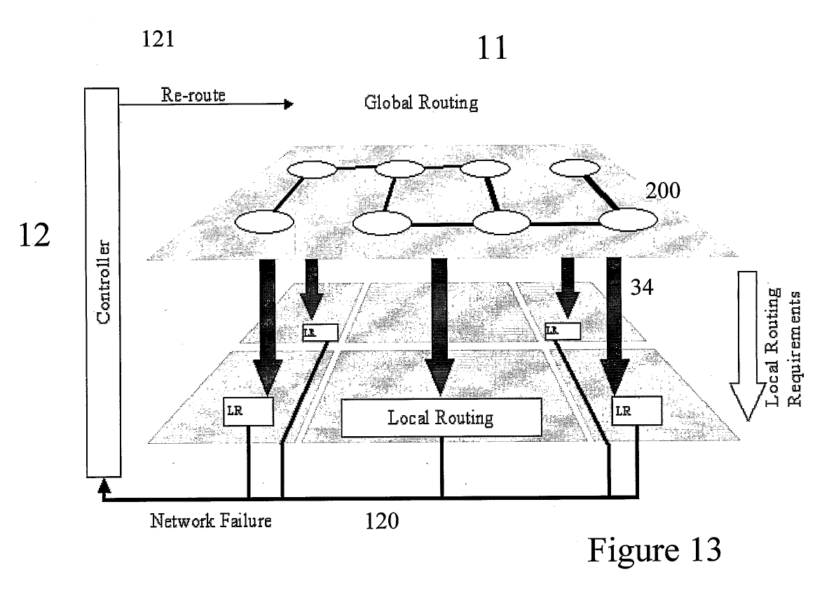

FIG. 13 illustrates the use of feedback from the network to control the routing process

A number of network optimisation methods have been developed to handle resource allocation problems. One such process is described in a paper by Conway et al: “iNetwork—A Framework for Network Optimisation”: Proceedings of the International Network Optimization Conference, 2003 p163-168). This process provides a number of generic tools for the modelling and visualisation of networks and the application of specialised network algorithms, together with more specialised extensions targeted at specific categories of network optimisation problems such as network routing, and design. It brings together techniques from Metaheuristics, Graph Theory and Network Flow together with comprehensive network modelling and advanced visualisation capabilities.

FIG. 1 illustrates schematically the various processes which interact to perform the process. The principal elements are a network partitioning process 10, a path selection component 11, and a network feedback and control process 12. The network partitioning process 10 defines an internal structure to the network, which is then stored 13. The path selection component 11 receives requests from an input 14 and selects suitable paths to meet those requests, making use of the stored internal structure 13. The paths selected are then put into operation in the network itself 15. The network 15 returns information on performance, reconfiguration and so on which are fed to the feedback and control processor 12 to inform the path selection component 11 and, if required, the partitioning processor 10.

FIG. 2 illustrates a simple network 20. Even for such a simple network it can be seen that the number of possible routes between any two nodes (e.g. 21, 29) in the network is quite large. FIGS. 3, 4 and 5 depict how route-finding may be simplified by spatially partitioning the network into a number of smaller network parts. According to the invention, the path allocation process 11 considers the network 20 as subdivided into a number of simpler subsidiary networks 30, 31, 32, 33, 34, 35 (FIG. 3). Routing across each of these individual subsidiary networks is relatively straightforward. Each connection between nodes in different subsidiary networks (e.g. nodes 22, 23) is represented by a respective pair of port nodes 302, 312; 303, 313 etc (shown in white in FIGS. 3 and 4).

FIGS. 6 and 7 illustrate a more complex network, partitioned into eight subsidiary networks 71, 72, 73, 74, 75, 76, 77, 78, again with pairs of port nodes defined between them. (Note that in these two Figures each such pair is represented by a single node, e.g. 61). More specifically FIG. 6 illustrates one subsidiary network 71, (equivalent to one of the networks 31, 32 etc in FIG. 3) showing the internal connectivity and the port nodes 61, 62, 63, . . . 67. FIG. 7 illustrates the connectivity of the subsidiary networks 71, 72, 73, 74, 75, 86, 77, 78, including the port nodes 61, 62, 63 . . . 67, and is equivalent to the depiction in FIG. 4. For the purposes of illustration, the boundaries of the subsidiary networks 71, 72 etc coincide with national boundaries. This need not necessarily be the case—the subsidiary networks are defined to simplify the routing problem, and this is best achieved by minimising the number of port nodes at each level. However, if the number of international links are small, either because there is significantly less international traffic than domestic traffic, or because topographical barriers coinciding with the frontiers, such as mountains or the sea, require concentration of such links on a small number of high-capacity routes, national boundaries may be the optimum boundaries for the subsidiary networks. It will be seen that routing in a network of this complexity, which is likely to be subject to frequent changes, is a complex problem.

Returning to the simplified network of FIGS. 2 to 5, networks of greater complexity can be repeatedly partitioned until sub-networks of a suitable size are achieved thereby forming a multi-layer routing model. This is illustrated in FIG. 8, in which one of the subsidiary networks 33 has itself been subdivided into four smaller networks 81, 82, 83, 84.

As shown in FIG. 4, an inter-port connectivity network 40, 41, 42, 43, 44, 45 is created for each of the subsidiary networks 30, 31, 32, 33, 34, 35. An inter-port network represents the internal routing between pairs of port nodes (for example routing 421 between port nodes 312, 324 in subsidiary network 32, and 441 between port nodes 334, 345 in subsidiary network 34). This intra-port network essentially represents a summary of the network and the ability to route through and into the network. In each subsidiary network there are n(n−1)/2 routes to determine, where n is the number of ports in that subsidiary network. The intra port networks can be built using a number of alternative routing methods, such as shortest path, k-shortest path and maximum flow algorithms.

FIG. 5 illustrates the merging of all inter-port networks into a new global routing network 50 encapsulating interconnectivity and potential network throughput for all the partitioned networks 40, 41 etc. The total number of connections between subsidiary networks is given by SUM (n/2), where n is the number of ports in each network. This global network can then be used to find a high-level path allocation, which satisfies the service request at a high level. The total number of routing elements for the large network to determine is thus SUM (n/2)+SUM n(n−1))/2 which reduces to SUM (n²)/2. It will be apparent that the optimum points in the network to define the port nodes are such that the number of connections between subsidiary networks are minimised.

Having found a broad solution to the path allocation, a detailed solution can then be provided by considering the global paths as being comprised of multiple paths segments through a number of the partitioned networks. FIGS. 9 to 11 show an illustrative response to a request for a path between nodes 21, 29 in two different subsidiary networks 30, 35. FIG. 9 illustrates the subsidiary networks 30, 32, 34, 35, and the respective port nodes 302, 312, 324, 334, 345, 355, identified as delivering the optimum route. FIG. 10 illustrates the inter-port networks 421, 441 within the intermediate subsidiary networks 42, 44, and FIG. 11 illustrates the actual end-to end route 200. Note that in some subsidiary networks more than one port-to-port route (or endpoint to port route) is available—for example in subsidiary network 34 routing from port 334 to port 345 can be through either node 24 or node 25—or indeed if sufficient capacity is required, a combination of the two. The optimum route within each subsidiary network is selected by the processor for that network: the overall route selection process has no visibility of any sub-optimal routes within the individual subsidiary networks.

The global paths selected thereby place routing requirements on each of the network parts. In this way each smaller network part becomes responsible for routing traffic through and into itself. A complete end-to-end path 200 is therefore a composite path formed by the routes allocated through and between each network part 30, 31, 32, 33, 34, 35, as shown in FIG. 11, and specifically of a series of connections between network ports. Each network port (e.g. 312) is connected with both another network port in the same subordinate network 32 (e.g. network port 324), and to its own associated network port 302, which is in another subordinate network 30.

The selection of a set of feasible paths in order to meet the capacity and QoS demands of the service requests is carried out by a Path Selection Component 11. This component is used both at the global routing level and at the local level within the network parts. The component utilises Heuristic Search methods to select a path for each service request from a number of alternate paths discovered for each service request. The search for the alternative paths is carried out, for example, by a k-shortest path search. The Path Selection is cast as a Cost Optimisation Problem where the objective is to globally achieve the lowest cost for allocated paths and to minimise the number of broken constraints, such as upper bounds on the capacity carried by each network link, and the end-to-end path Delay.

Within the Path Selection Component 11, modelling of the problem is independent of the heuristic method chosen. Indeed once the modelling is done a suitable heuristic method can be chosen from a library of pre-defined methods or a new method can be constructed. In this way a fair comparison of the performance of each method can be carried out and the best performer chosen. In simulations, it appears that a Simulated Annealing based approach converges to satisfactory results in reasonable time. However, the performance or benefits of a particular heuristic method over another is problem-specific, with certain methods performing well with certain types of problem (depending on network topology and set of requests). Knowing beforehand which method will be best is difficult. However the modular design of the iNetwork toolkit referred to above allows one method 112 to be simply exchanged for another 111, and to compare results, as illustrated in FIG. 12. This can be done, for example, after a change in network topology, to determine whether, following the change, a different heuristic algorithm is more appropriate than the one used hitherto.

The Network Feedback and Control component 12 will now be discussed, with reference to FIG. 13. From time to time an allocated routing 200 may fail. Failure to route could be the result of a temporary or permanent change in the real network, or simply an excess requirement placed upon the network. Routing failures generally occur because of a localised problem, leaving most previously allocated routes unaffected. Re-routing at the global level starting from a previous solution tends to leave these already discovered paths unaffected. In those cases where a routing allocation across a network part 34 fails, the network reports the failure to the routing feedback controller 12 (step 120) which transmits an instruction 121 to the global routing function 11 to generate an alternative route, taking into account the reduced capacity of the subsidiary network 34 in which the failure has been identified. The global routing function 11 can therefore utilise previous solutions as its new initial condition allowing a quicker convergence to a feasible solution. By changing the parameters of only the failed subsidiary network 34, it is, thus still possible to identify a suitable route allocation.

Changes to the network do not require complete reconfiguration of the route-finding process, but only to that part of the process concerned with the affected subsidiary network 34. Similarly, changes to the connections between subsidiary networks, for example creating or amending a connection between two subsidiary networks only requires amendment of the model of the overlay network and the two subsidiary networks directly involved. Furthermore, in a multi-level model, such changes do not affect the model at other levels.

1-19. (canceled)

20. A method of operating a management system for a network in order to satisfy requests for a set of concurrent complete connection paths to be reserved in the network, each path requiring specified performance attributes, the network comprising a plurality of connections between network nodes, each connection having a predetermined capacity, the method comprising defining a plurality of distinct subsidiary networks, each comprising a subset of the nodes making up the complete network and the connections between the subset of nodes, and in which a connection path is determined by identifying connection path elements between interface nodes in each subsidiary network, and identifying connections between the subsidiary networks, and selecting a complete connection path by combining the connection path elements so identified.

21. A method according to claim 20, in which the subsidiary networks are defined such that the number of connections between them are minimised

22. A method according to claim 21, in which routes within a subsidiary network are identified between each pair of port nodes in the subsidiary network, and routes between the subsidiary networks are defined according to the pairs of port nodes connecting them.

23. A method according to claim 20, in which a connection between two subsidiary networks is defined by a pair of port nodes, one in each of the subsidiary networks, and connections across and between subsidiary networks are defined by routes between the port nodes.

24. A method according to claim 20, wherein one or more of the subsidiaries levels is itself subdivided into further subsidiaries.

25. A method according to claim 20, in which the process is controlled by one or more suitably-programmed general-purpose computers.

26. A network management system for allocating a set of concurrent complete connection paths between terminations of a network, the network comprising a plurality of connections between network nodes, each connection having predetermined performance attributes, the system comprising: input means for accepting a request for a connection path, means for defining a plurality of distinct subsidiary networks and storing the details thereof, each subsidiary network comprising a subset of the nodes making up the complete network and the connections between the subset of nodes, means for storing the details of connections between the subsidiary networks, means associated with each subsidiary network for identifying connection paths between its interface nodes, means for identifying connection paths between the subsidiary networks, and means for selecting a complete connection path by combining the connection path elements so identified.

27. A network management system according to claim 26, in which the subsidiary networks are defined such that the number of connections between them are minimised.

28. A network management system according to claim 26, in which the means for defining the subsidiary networks defines a pair of port nodes representing the connection between two subsidiary networks, one of the pair being associated with each of the subsidiary networks, and defines connections across and between subsidiary networks by routes between the port nodes.

29. A network management system according to claim 28, comprising means for identifying the routes within a subsidiary network between each pair of port nodes, and means for defining routes between the subsidiary networks according to the pairs of port nodes connecting them.

30. A network management system according to claim 26, in which one or more of the subsidiary networks is itself subdivided into further subsidiary networks.

31. A network management system according to claim 26, comprising one or more suitably-programmed general-purpose computers.

32. A computer program or suite of computer programs for use with one or more computers to carry out the method as set out in claim 20.
